(19) United States
(12) Patent Application Publication
(10) Pub. No.: US 2026/0126669 A1
(43) Pub. Date: May 7, 2026

(54) ADJUSTABLE NOSE BRIDGE VIA A HINGE WITH PREDEFINED STEPS FOR A PAIR OF SMART GLASSES

(71) Applicant: Meta Platforms Technologies, LLC, Menlo Park, CA (US)

(72) Inventors: Rolando Abella Pausal, Kirkland, WA (US); Inès Le Bihan, Seattle, WA (US); Peter Wesley Bristol, Seattle, WA (US)

(21) Appl. No.: 19/312,192

(22) Filed: Aug. 27, 2025

Related U.S. Application Data
(60) Provisional application No. 63/688,248, filed on Aug. 28, 2024.

(51) Int. Cl. G02C 5/12; G02B 27/01

(52) U.S. Cl. CPC G02C 5/122; G02B 27/0176; G02B 2027/0178

(57) ABSTRACT

An example augmented-reality headset comprises a lens frame and a nose pad coupled to the lens frame. The nose pad is rotatably coupled to the frame along an axis, and the nose pad is configured to rotate between a first position and a second position, and the first position has a first angle along the axis relative to a surface of the lens frame and the second position has a second angle along the axis relative to the surface of the lens frame, wherein the first angle is different from the second angle.

### RELATED APPLICATIONS

This application claims priority to U.S. Provisional Application Ser. No. 63/688,248, filed Aug. 28, 2024, titled “Adjustable Nose Bridge Via a Hinge with Predefined Steps for a Pair of Smart Glasses,” which is hereby incorporated by reference in its entirety.

### TECHNICAL FIELD

This relates generally to having adjustable nose pads on a pair of smart glasses that allow for users with different facial profiles to have the same comfort and viewing experience.

### BACKGROUND

Glasses with adjustable nose pads have been used to accommodate users with different nose bridges (e.g., high and low nose bridges). However, traditional adjustable nose pads for traditional glasses are not subject to the same constraints as adjustable nose pads for a pair of smart glasses, such as a consistent way to adjust the adjustable nose pads to a particular position or a consistent way to return the adjustable nose pads to a previous position after adjustment. As such there is a need to have adjustable nose pads that work with smart glasses.

As such, there is a need to address one or more of the above-identified challenges. A brief summary of solutions to the issues noted above are described below.

### SUMMARY

As will be discussed herein, a pair of augmented-reality (AR) glasses or pair of smart glasses that include an adjustable nose bridge that includes a ratcheting assembly resolve the challenges described above. An example AR headset (e.g., glasses 100 shown in FIG. 1 can be an AR headset or another type of smart glasses, extended-reality headset, or AR headset) comprises a lens frame (e.g., FIG. 1 shows a frame portion 102 that houses one or more lens and/or waveguides). The AR headset also comprises a nose pad coupled to the lens frame (e.g., FIG. 1 shows an adjustable nose pad 104). The nose pad is rotatably coupled to the frame along an axis (e.g., FIG. 2 shows the adjustable nose pad 200 rotating about an axis 201), and the nose pad is configured to rotate between a first position and a second position, and the first position has a first angle along the axis relative to a surface of the lens frame and the second position has a second angle along the axis relative to the surface of the lens frame, wherein the first angle is different from the second angle (e.g., FIG. 2 shows that the nose pad 200 can move between at least four positions, as illustrated by position 1 (202), position 2 (203), position 3 (204), position 4 (206)). In some embodiments, the first angle accommodates a first nose bridge of a user (e.g., a low nose bridge) and the second angle accommodates a second nose bridge (e.g., different in shape than the first nose bridge) of another user (e.g., a high nose bridge). In some embodiments, the nose pad's position can be adjusted along one or more other axes that is different than the axis described above (e.g., a tilting axis).

Having an adjustable nose bridge is advantageous, as it allows for more individuals to comfortably experience an augmented reality experience. Additionally, having an adjustable nose pad allows for a single SKU to be produced instead of needing to have multiple SKUs to accommodate nose bridges of different users.

While this application makes reference to the adjustable nose bridge being incorporated into a pair of augmented-reality glasses, one skilled in the art would appreciate that the adjustable nose bridge can be incorporated into any eye-piece (e.g., a pair of smart glasses) that a user can don. For example, the adjustable nose bridge assembly can be included in a pair of display-less smart glasses, virtual reality headset, mixed-reality headset, traditional glasses, etc.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or an augmented-reality (AR) headset as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates a portion of a lens frame of a pair of glasses (e.g., a pair of traditional glasses, sunglasses, smart glasses, augmented-reality glasses, etc.) that includes an adjustable nose pad that can be rotated to accommodate different facial profiles, in accordance with some embodiments.

FIG. 2 illustrates a cutaway view of the adjustable nose pad described in FIG. 1 and further illustrates the angles in which the nose pad can rotate, in accordance with some embodiments.

FIG. 3 shows how much torque is required to change positions of the nose pad, in accordance with some embodiments.

FIG. 4 shows the nose pad ratcheting assembly discussed in the preceding figures in further detail, in accordance with some embodiments.

FIG. 5 shows an example method flow chart 500 for manufacturing a pair of glasses (e.g., smart glasses) with an adjustable nose pad, in accordance with some embodiments.

FIGS. 6A 6B, and 6C-1 and 6C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application, the term “extended reality (XR)” is used as a catchall term to cover both ARs and MRs. In addition, this application also uses, at times, a head-wearable device or headset device as a catchall term that covers XR headsets such as AR headsets and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Adjustable Nose Bridge

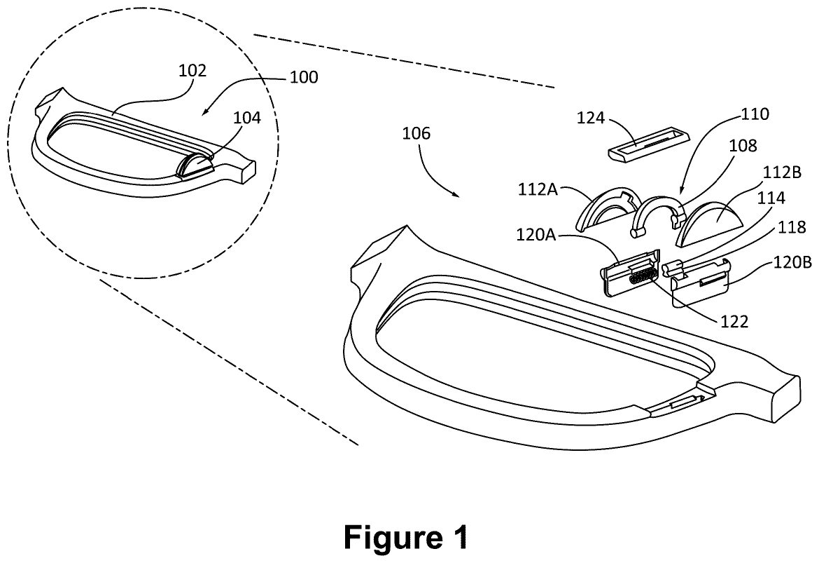

FIG. 1 illustrates a portion of a lens frame of a pair of glasses (e.g., a pair of traditional glasses, sunglasses, smart glasses, augmented-reality glasses, etc.) that includes an adjustable nose pad that can be rotated to accommodate different facial profiles, in accordance with some embodiments. As shown the glasses 100 include a frame portion 102 and an adjustable nose pad 104. While only a single nose pad 104 is shown, it is understood that a similar adjustable nose pad can replace the traditional nose pads of glasses.

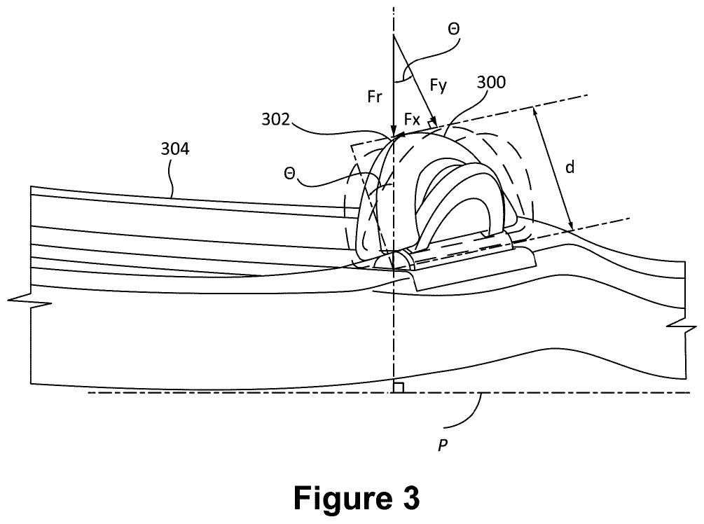

FIG. 1 further illustrates an exploded view 106 of the adjustable nose pad 104. The exploded view 106 of the adjustable nose pad 104 illustrates multiple components that are described herein. The exploded view 106 shows that the adjustable nose pad 104 comprises a hinge 108 that includes a first portion of a ratchet 110. This hinge 108 can be comprised of different materials, including but limited to metal, plastic, composites, etc. In some embodiments, the hinge can be heat treated to increase hardness, the hardness being useful for ensuring that the teeth of the ratchet portion 110 (described in reference to FIG. 3) are not stripped or sheared off during adjustments of the adjustable nose pad 104.

The hinge is at least partially covered by a nose pad clam shell that is comprised of a first clam shell 112A and a second clam shell 112B. In some embodiments, the first clam shell 112A and 112B are bonded to each other by an adhesive or laser welded together. In some embodiments, the clam shell is overmolded onto the hinge and is comprised of a single structure. In some embodiments, the nose pad is comprised of plastic, polyurethane, silicone, and/or other soft touch material. In some embodiments, the nose pads can include a surface material that is different than the underlying material.

The ratchet portion 110 interfaces, via teeth, with a plunger 114 and controls the movement of the hinge 108. The plunger 114 also includes a guide 118 that fixes its movement to a single axis (e.g., such that gears on the plunger 114 remains fixed relative to the frame 102, while the gears on the hinge 108 rotate). The plunger 114 is placed in a barrel clam shell 120A and 120B that controls the movement of the plunger 114 relative to the hinge 108. The barrel clam shell 120A and 120B are affixed to one another and are used as the mounting point for the nose pad 104 within the frame 102 (e.g., attached via an adhesive to the frame 102). The barrel clam shell 120A and 120B also houses a spring 122 that is placed beneath the plunger 114 (e.g., on the aforementioned single axis). In some embodiments, the clam shell 120A and 120B can be molded or overmolded directly into the lens frame 102. The spring 122 resists movement of the plunger 114, which in turn holds the hinge 108 in place. Lastly, a cover 124 can be placed to reduce debris and moisture ingress and/or improve fit characteristics (e.g., user ergonomics) of the nose pad. The cover 124 can obscure and/or occlude the hinge 108.

In some embodiments, adjustments of the adjustable nose pad 104 of a pair of smart glasses cause an output device that is communicatively coupled to the smart glasses (e.g., a waveguide-based display of the smart glasses) to output a notification or indication that the nose pad has rotated (e.g., from a first position to a second position). In some embodiments, the smart glasses are configured to output information indicating a current position of the nose pad.

In some embodiments, the smart glasses include an actuator that controls movement or rotation of the adjustable nose pad 104. For example, in response to a user input to rotate the adjustable nose pad 104 from the first position to the second position, the actuator of the smart glasses adjusts the nose pads to the second position without further user input. In some embodiments, the actuator selectively moves the hinge 108 to move the adjustable nose pad 104. In some embodiments, the actuator selectively resists movement of the hinge 108 to allow or resist movement of the nose pad 104.

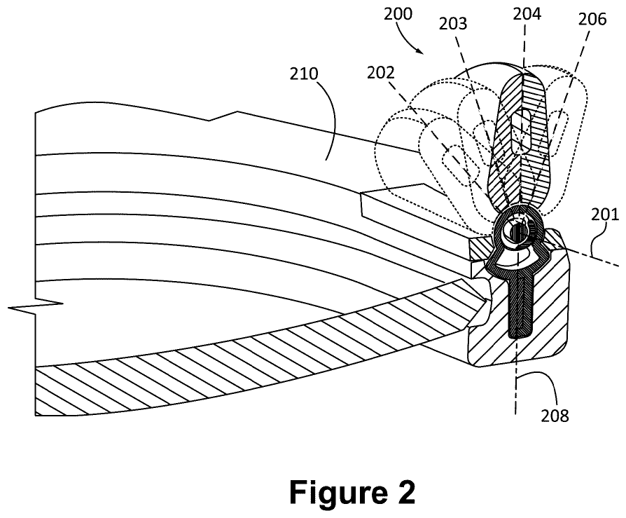

FIG. 2 illustrates a cutaway view of the adjustable nose pad described in FIG. 1 and further illustrates the angles in which the nose pad can rotate, in accordance with some embodiments. As shown in FIG. 2, the adjustable nose pad 200 can be adjustable between a plurality of positions thereby allowing a greater number of wearers to wear the glasses comfortably (i.e., reducing the overall number of SKUs). At least four positions are shown (position 1 (202), position 2 (203), position 3 (204), position 4 (206)), which can allow for a total adjustment range of at least sixty degrees. The profile, number, and spacing of the teeth of the ratchet component described in reference to FIG. 1 define the overall range of adjustability, force required, and the predefined positions within that range. While the example shown in FIG. 2 shows four different positions (e.g., in 18-degree increments with an overall range of 54 degrees), this can be redefined by selecting different teeth, teeth profiles, and/or controlling their spacing (e.g., 5 to 30 positions can be used along with a range up to 180 degrees can be used). As shown in FIG. 2, the nose pad 200 can move to both the right and left of the perpendicular axis 208 of the lens frame 210. In some embodiments, a friction surface instead of ratchet teeth can be used instead, thereby allowing for stepless adjustment of the position of the nose pad 200 relative to the frame 210.

FIG. 3 shows how much torque is required to change positions of the nose pad, in accordance with some embodiments. The nose pad 300 is configured to resist movement between positions until a force Fr exceeding an adjustment threshold is applied to the distal end 302 of the nose pad 300 (e.g., the highest point the nose pad 300 extends from the surface of the lens frame 304). For example, in some applications, a force Fr equal to or in excess of 5 newtons may exceed the adjustment threshold (e.g. overcomes the engagement of the teeth of the ratchet mechanism) and allow the nose pad 300 to move between positions. Further, based on an angle Q of the force Fr relative to a datum plane of the glasses frame P, a torque T exceeding an adjustment threshold required to move the nose pad 300 can be determined. First, an X component of force Fx can be calculated by the following equation:

$$F x = Fr ( sin Θ )$$

After determining the X component of force Fx, the X component of force Fx can be multiplied by a length d of the nose pad 300 to determine the torque T applied to the nose pad 300. For example, in some applications, a torque T equal to or in excess of a range of 10 to 20 newton millimeters may exceed the adjustment threshold and allow the nose pad 300 to move between positions. In some applications, the angle Θ of the force Fr relative to a datum plane of the glasses frame P is approximately 20 degrees (or 20.5 degrees), or in the range of 15 to 25 degrees. In some applications, the length d of the nose pad 300 is approximately 6 mm (or 6.14 mm) or in the range of 4 to 8 mm. For example, if the length d is approximately 6.14 mm and the X component of the force Fx is 1.55 N, the resulting torque T is 10.7 N-mm In some embodiments, the adjustment torque threshold is partially defined by the spring constant of the spring located within the nose pad 300 and can be adjusted depending on the use case. For example, a pair of glasses that might undergo more forces, such a glasses used in sports, can have a higher torque required to cause movement. In some embodiments, the nose pad 300 torque can be specified based on the glasses needing to be placed in a case (e.g., a charging case) without the process of placing the glasses in the case causing the nose pad 300 to move. For example, in a charging case that uses the nose pads to secure the glasses in the case, the force applied by the retention mechanism needs to be less than the force to cause movement of the nose pad 300. In some embodiments, the adjustment torque threshold is increased by a safety factor. In some applications, the safety factor can be approximately 1.5 times greater than the expected force (e.g., expected torque associated with sports usage or expected torque from the retention mechanism) or in the range of 1 to 5 times greater than the expected force. Increasing the adjustment torque threshold decreases the likelihood of unintended adjustment of the nose pad 300, and decreasing the adjustment torque threshold increases user ergonomics associated with adjusting the nose pad 300 (e.g., case of adjusting the nose pad 300). During operation, the nose pads 300 can remain in a current position when the torque is less than the adjustment torque threshold.

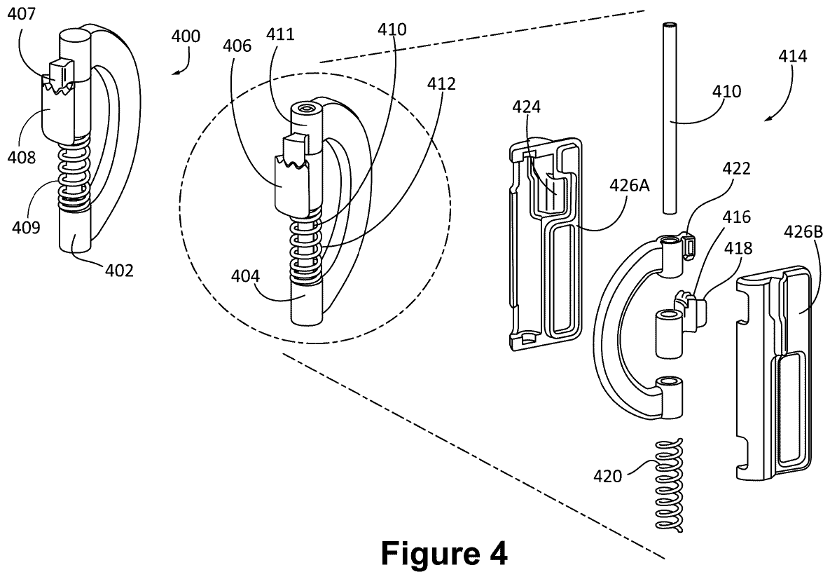

FIG. 4 shows the nose pad ratcheting assembly discussed in the preceding figures in further detail, in accordance with some embodiments. FIG. 4 shows in a ratchet assembly 400 of a first type 402 and a second type 404.

The ratchet assembly 400 of the first type 402 includes a first portion 407 of the ratchet assembly 400 with a single tooth that is selectively engaged with the first plunger 408. The first portion 407 of the ratchet assembly can engage with the plunger 408 in one of several predefined positions relative to the plunger 408, where the predefined positions are defined by the space between teeth of the plunger 408. These predefined positions correspond to position 1 (202), position 2 (203), position 3 (204), and position 4 (206) as shown in FIG. 2. For example, when the first portion 407 is engaged with the plunger 408, the single tooth of the first portion 408 is positioned between two teeth of the plunger 408.

In response to a sufficient torque applied to the hinge (e.g., via the nose pad), the first portion 407 of the ratchet assembly 400 rotates relative to the plunger 408 and causes the plunger 408 to compress the spring 409. This continues as the torque continues to be applied until the single tooth of the first portion 407 of the ratchet assembly rotates past one of the two teeth of the plunger. The compressed spring 409 then causes the plunger 408 to move upwards, thereby “snapping” the first portion 407 of the ratch to the second predefined position (e.g., the spring 409 biases the plunger into engagement with the plunger 408). For example, in response to a sufficient torque applied to the ratchet assembly 400 of the first type 402, the first portion 407 rotates from a space between a first tooth and a second tooth of the plunger 408 to a space between the second tooth and a third tooth of the plunger 408. In another example, when an insufficient amount of torque is applied (e.g., an amount less than a nose-pad adjustment threshold), the hinge, ratchet assembly 407, and/or nose pad remain in its current position (e.g., remains station in one of the predefined positions). In this example, the plunger 408 resists rotation or movement of the first portion 407, thereby preventing the hinge, ratchet assembly 407, and/or nose pad from moving to a predefined position that is different from the current predefined position.

The ratchet assembly 400 of the second type 404 is different from the first type 402 in that the plunger 406 includes additional teeth as compared to the first plunger 408 of the first type 402. For example, as shown in FIG. 4, the plunger 406 includes two teeth that can selectively engage with the first portion 411 of the ratchet assembly 400 of the second type 404. The multiple teeth of the second plunger 406 distributes the force amongst the multiple teeth (e.g., reduces the load on any given location or tooth), thereby improving longevity of the ratcheting mechanism (e.g., reduces wear and/or damage). The ratchet assembly 400 of the second type 404 includes a shaft 410, which can be useful during the manufacturing process for ensuring proper alignment between the second plunger and the spring 412.

For both the ratchet assembly of the first type 402 and the second type 404, the torque required to actuate the ratchet assembly 400 is based, at least in part, on an angle of the teeth of the first portion 407, 411 of the ratchet or the plunger 408, 406, respectively. A shallower angle as measured at the tip of a respective tooth decreases the torque required to actuate the ratchet assembly 400, and a sharper angle increases the torque required to actuate the ratchet assembly 400. The angle of the teeth works in conjunction with the force from the spring 409, 412 to increase or decrease the required torque to rotate the ratchet assembly 400 (and the nose pad).

In some embodiments, the spring 412 can be a leaf spring, a compression spring, a torsion spring, or a pressurized canister.

FIG. 4 also shows another exploded view 414 of the second type 404 which further illustrates the individual components of the ratchet assembly. The one difference that is shown in the exploded view 414 is that the plunger 416 includes a guide 418 which ensures that the plunger 416 only moves up and down with the spring 420 when a force is applied to the hinge 422. The guide 418 interfaces with a corresponding guide cutout 424 that is found on both sides of the clam shell barrels 426A and 426B (e.g., similar to a piston moving up and down).

In some embodiments, FIG. 4 can include an electrically controlled actuator for controlling the movement of the hinge 422 (e.g., a direct drive motor can be used in conjunction with the ratcheting assembly to control movement). In some embodiments, an electrically controlled actuator can use an inward facing camera to determine the correct position of the nose pads relative to a nose of a user.

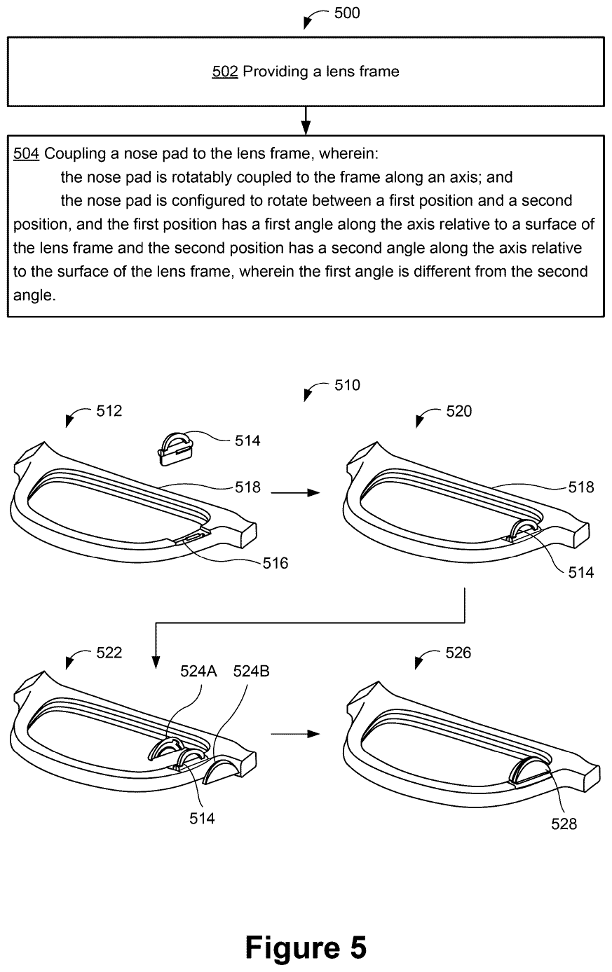

(A1) FIG. 5 shows an example method flow chart 500 for manufacturing a pair of glasses (e.g., smart glasses) with an adjustable nose pad, in accordance with some embodiments. The method of manufacture comprises providing 502 a lens frame. Then method also includes coupling 504 a nose pad to the lens frame. The nose pad is rotatably coupled to the frame along an axis, and the nose pad is configured to rotate between a first position and a second position, and the first position has a first angle along the axis relative to a surface of the lens frame and the second position has a second angle along the axis relative to the surface of the lens frame, wherein the first angle is different from the second angle.

(A2) In some embodiments of A1, the lens frame is a lens frame of an extended-reality headset.

(A2) In some embodiments of A1, the nose pad is configured in accordance with any B1-E2.

(B1) In accordance with some embodiments an augmented-reality (AR) headset (e.g., glasses 100 shown in FIG. 1 can be a pair of smart glasses, an AR headset, or another type of extended-reality headset), comprises a lens frame (e.g., FIG. 1 shows a frame portion 102 that houses one or more lens and/or waveguides). The AR headset also comprises a nose pad coupled to the lens frame (e.g., FIG. 1 shows an adjustable nose pad 104). The nose pad is rotatably coupled to the frame along an axis (e.g., FIG. 2 shows the adjustable nose pad 200 rotating about an axis 201), and the nose pad is configured to rotate between a first position and a second position, and the first position has a first angle along the axis relative to a surface of the lens frame and the second position has a second angle along the axis relative to the surface of the lens frame, wherein the first angle is different from the second angle (e.g., FIG. 2 shows that the nose pad 200 can move between at least four positions, as illustrated by position 1 (202), position 2 (203), position 3 (204), position 4 (206)). In some embodiments, the first angle accommodates a first nose bridge of a user (e.g., a low nose bridge) and the second angle accommodates a second nose bridge (e.g., different in shape than the first nose bridge) of another user (e.g., a high nose bridge).

(B2) In some embodiments of B1, the axis is along a major axis of the nose pad (e.g., FIG. 2 shows that the axis 201 corresponds to a major length of the nose pad).

(B3) In some embodiments of any of B1-B2, the first angle is configured to be up to sixty degrees different from the second angle (e.g., as described in reference to FIG. 2 the maximum range can be at least sixty degrees).

(B4) In some embodiments of any of B1-B3, the nose pad includes ratchet that controls the movement between the first position and second position. For example, FIG. 4 describes a ratcheting assembly 400 of a first type 402 and a second type 404.

(B5) In some embodiments of B4, the ratchet is spring loaded. For example, FIG. 4 shows that a spring 412 and 420 can be used to control the movement of the plunger 40, 404, and 416 of the ratcheting assembly 400.

(B6) In some embodiments of any of B1-B5, the nose pad is configured to move between the first position and the second position when a torque applied at a distal end of the nose pad is greater than 10 newton-millimeters, further wherein the distal end is at a location that is substantially perpendicular to the axis. For example, FIG. 3 shows that a force can be applied (e.g., by a finger of a user) to a distal end 302 of the nose pad 300 to cause it to move (i.e., the amount of torque is based on the distance the nose pad 300 is from the glasses frame 304).

(B7) In some embodiments of B6, the torque is 16 newton-millimeters.

(B8) In some embodiments of any of B1-B7, the first angle is an angle relative to a perpendicular axis that is in a first direction up to 90 degrees from the perpendicular axis, and the second angle is an angle relative to the perpendicular axis that is in a second direction up to 90 degrees from the perpendicular axis. For example FIG. 2 shows that nose pad 200 can move to either side of the perpendicular axis 208.

(B9) In some embodiments of any of B1-B8, the augmented-reality headset includes an output device (e.g., a display, a speaker, a haptic feedback generator) that is configured to present a notification indicating that the nose pad has moved between the first position and the second position. As described in reference to FIG. 1 the glasses 100 can be a pair of augmented-reality glasses that include a waveguide for presenting an AR augment to the user.

(B10) In some embodiments of any of B1-B9, the augmented-reality headset includes an actuator (e.g., an electric motor, a linear actuator, a pressurized motor, etc.) that controls the movement of the nose pad between the first position and the second position. For example, electrically controlled actuators are described in reference to FIG. 4.

(B11) In some embodiments of any of B1-B10, AR headset further comprises another nose pad coupled to the lens frame. The other nose pad is rotatably coupled to the frame along an axis, and the other nose pad is configured to rotate between a third position and a fourth position, and the third position has a third angle along the other axis relative to the surface of the lens frame and the fourth position has a fourth angle along the axis relative to the surface of the lens frame, wherein the third angle is different from the fourth angle. FIG. 1 describes a single nose pad but it is understood and described in reference to figure one that two nose pads can be used on a single pair of glasses (e.g., replacing traditional nose pads on glasses).

(B12) In some embodiments of any of B1-B11, the AR headset further comprises a ratchet assembly that includes a hinge, a plunger, and a spring. The hinge and nose pad are rotatable relative to the lens frame. The plunger is in selective engagement with the hinge, and the plunger resists rotation of the hinge. Additionally, the spring biases the plunger into engagement with the hinge. For example, FIG. 4 describes a ratchet assembly 400 of a first type 402 and a second type 404, both of which include a respective hinge, a respective plunger, and a respective spring.

(B13) In some embodiments of any of B1-12, the plunger and the hinge are at least partially disengaged when the nose pad is in a position other than the first position or the second position as the nose pad rotates between the first position and the second position. Additionally, the plunger and the hinge are engaged when the first nose pad is at the first position or the second position. For example, FIG. 4 describes the plunger 408, 406 and the first portion 407, 411 engaged. It is understood that a partial disengagement occurs when the hinge is rotated, causing the plunger to move downwards and thus at least partially disengaging.

(B14) In some embodiments of any of B1-13, the AR headset includes an output device that is configured to present information indicating a current position of the first nose pad.

(B15) In some embodiments of any of B1-B14, the AR headset includes an output device that is configured to present a notification indicating that the first nose pad has rotated between the first position and the second position.

(B16) In some embodiments of any of B1-B15, the AR headset includes an actuator that controls movement of the first nose pad between the first position and the second position, wherein the actuator is electronically controlled by the smart glasses.

(C1) In accordance with some embodiments, a pair of glasses comprises a lens frame and a nose pad coupled to the lens frame. The nose pad is rotatably coupled to the frame along an axis, and the nose pad is rotatably coupled via a hinge that has its position controlled by at least a spring that resists movement of the nose pad. For example, FIG. 1 describes a pair of glasses 100 that include a frame portion 102 and an adjustable nose pad 104,

(C2) In some embodiments of C1, the pair of glasses further comprise a ratchet that defines positions at which the nose pad can be rotated to along the axis and the spring controls the movement of the ratchet. For example, FIG. 2 shows four predefined positions in which the nose pad can rest out.

(C3) In some embodiments of any of C1-C2, the axis is along a major axis of the nose pad (e.g., FIG. 2 shows that the axis 201 corresponds to a major length of the nose pad).

(C4) In some embodiments of any of C1-C3, the position of the hinge can vary by at least sixty degrees (e.g., as described in reference to FIG. 2 the maximum range can be at least sixty degrees).

(C5) In some embodiments of any of C1-C4, the nose pad is configured to have the position changed in response to a torque being applied at a distal end of the nose pad that is greater than 10 newton-millimeters, further wherein the distal end is at a location that is substantially perpendicular to the axis. For example, FIG. 3 shows that a force can be applied (e.g., by a finger of a user) to a distal end 302 of the nose pad 300 to cause it to move (i.e., the amount of torque is based on the distance the nose pad 300 is from the glasses frame 304).

(C6) In some embodiments of C5, the torque is 16 newton-millimeters.

(C7) In some embodiments of any of C1-C6, the position of the nose pad is configured to: move between a first angle that is up to 90 degrees in a first direction relative to a perpendicular axis, and move between a second angle that up to 90 degrees in a second direction relative to the perpendicular axis. For example FIG. 2 shows that nose pad 200 can move to either side of the perpendicular axis 208.

(C8) In some embodiments of any of C1-C7, the pair of glasses further comprise another nose pad coupled to the lens frame. In some embodiments, the other nose pad is rotatably coupled to the frame along an axis, and the other nose pad is rotatably coupled via another hinge that has its position controlled by at least another spring that resists movement of the other nose pad. FIG. 1 describes a single nose pad but it is understood and described in reference to figure one that two nose pads can be used on a single pair of glasses (e.g., replacing traditional nose pads on glasses).

(D1) In accordance with some embodiments, a nose pad comprises a component configured to interface with a lens frame. The nose pad is rotatably coupled to the lens frame along an axis, and the nose pad is configured to rotate between a first position and a second position, and the first position has a first angle along the axis relative to a surface of the lens frame and the second position has a second angle along the axis relative to the surface of the lens frame, wherein the first angle is different from the second angle. For example, FIGS. 1-4 describe an adjustable nose pad that can be used on a pair glasses.

(D2) In some embodiments of D1, the lens frame is a lens frame of an extended-reality headset. For example, FIG. 1 describes that the glasses can be a pair of augmented-reality glasses or other type of extended reality glasses.

(D3) In some embodiments of any of D1-D2, the nose pad is configured in accordance with any of A1-C8 and E1-E2.

(E1) In accordance with some embodiments, a non-transitory, computer-readable storage medium includes executable instructions that, when executed by one or more processors of an augmented-reality (AR) system, cause the one or more processors to perform or cause performance of presentation of an AR, wherein an AR headset of the AR system is configured in accordance with any of A1-D3.

(E2) In accordance with some embodiments, a method of presenting an augmented-reality at an augmented reality headset, wherein the augmented-reality headset is configured in accordance with any of A1-D3.

FIG. 5 also illustrates a visual depiction of the assembly process for coupling the adjustable nose pad to the lens frame (e.g., a lens frame of a pair of smart glasses), in accordance with some embodiments. FIG. 5 shows a sequence 510 that first illustrates, in a first pane 512, that a partially assembled adjustable nose pad 514 is configured to be inserted into a cavity 516 of the lens frame 518. A second pane 520 shows that the partially assembled adjustable nose pad 514 is inserted into the cavity 516 of the lens frame 518. A third pane 522 shows a first clam shell half 524A and the second clam shell half 524B that are configured to surround the partially assembled adjustable nose pad 514. A fourth pane 526 shows the first clam shell half 524A and the second claim shell half 524B are attached to the partially assembled nose pad 514 to produce a fully assembled nose pad 528. In some embodiments, the first clam shell half 524A and the second clam shell half 524B are laser welded together and/or glued together.

### Example Extended-Reality Systems

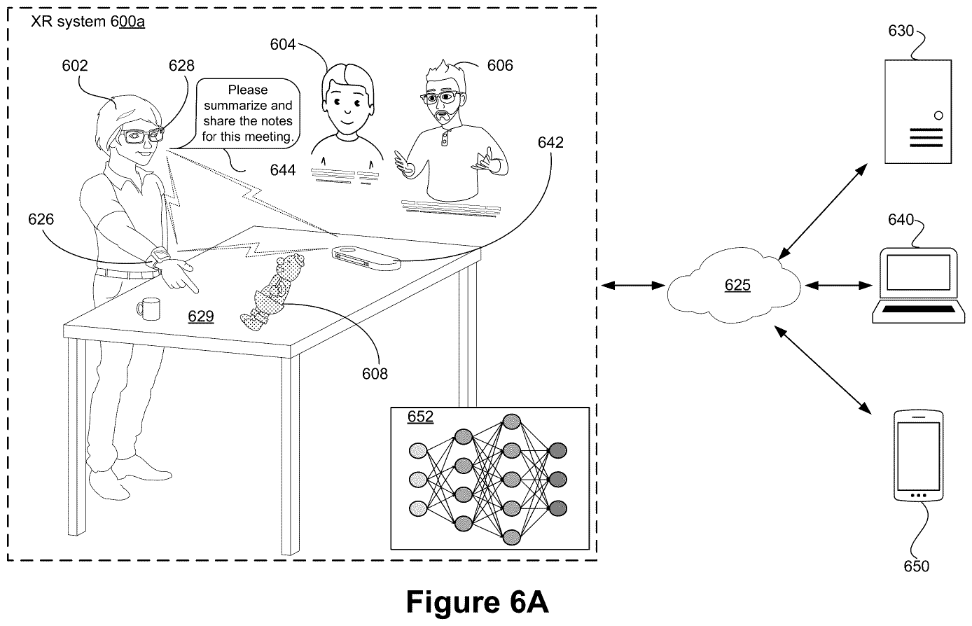

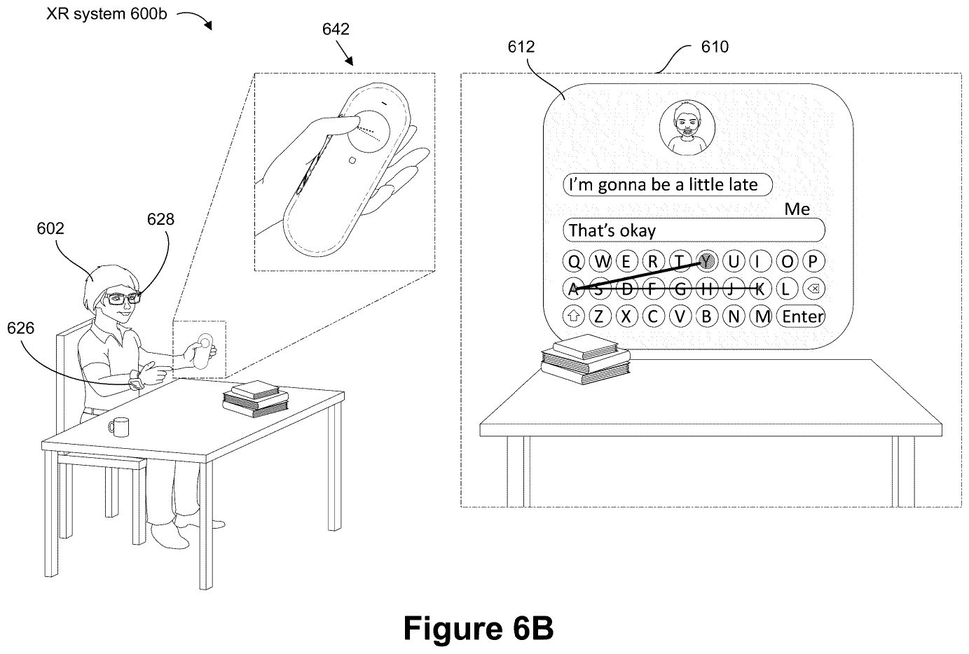

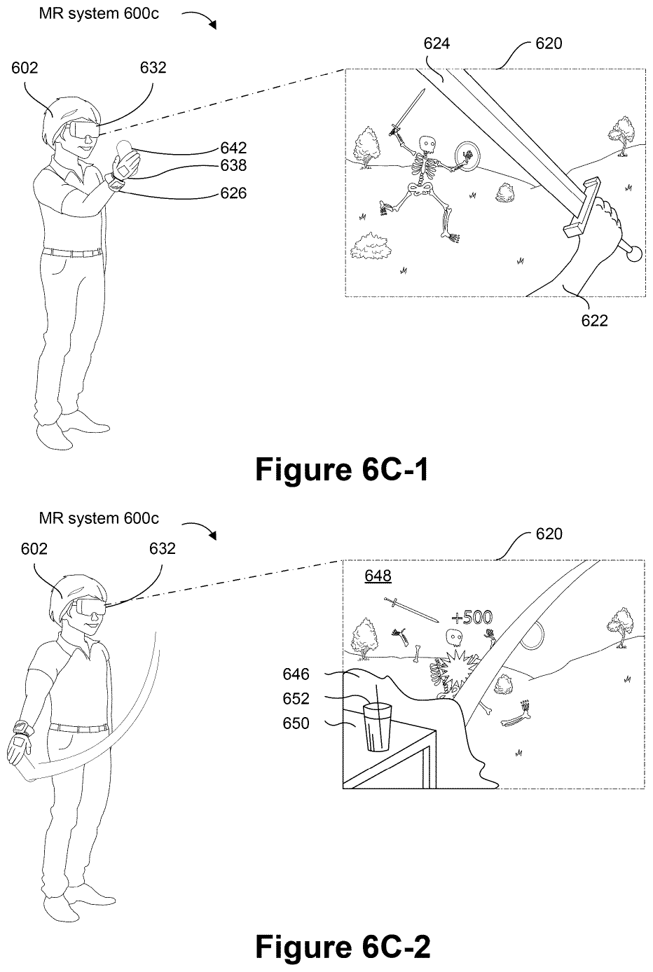

FIGS. 6A 6B, 6C-1, and 6C-2, illustrate example XR systems that include AR and MR systems, in accordance with some embodiments. FIG. 6A shows a first XR system 600a and first example user interactions using a wrist-wearable device 626, a head-wearable device (e.g., AR device 628), and/or a HIPD 642. FIG. 6B shows a second XR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), and/or an HIPD 642. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, and/or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user's extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the user 602's eyes for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608.

Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

Integration of Artificial Intelligence with XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602's field of view 610). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602's gestures performed on the HIPD 642 can be provided and/or displayed on another device. For example, the user 602's swipe gestures performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the user 602's motion. For example, image sensors (e.g., SLAM cameras or other cameras) of the HIPD 642 can be used to detect a position of the HIPD 642 relative to the user 602's body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602's movements; and image sensors of the MR device 632 can be used to represent the user 602's body, boundary conditions, or real-world objects within the first MR game environment 620.

In FIG. 6C-2, the user 602 performs a downward swing while holding the HIPD 642. The user 602's downward swing is detected by the wrist-wearable device 626, the MR device 632, and/or the HIPD 642 and a corresponding action is performed in the first MR game environment 620. In some embodiments, the data captured by each device is used to improve the user's experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 650 and cup 652). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602's movements (while holding the HIPD 642) to cause the performance of corresponding actions within the first MR game environment 620. Additionally or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A-6B). While the MR device 632 presents a representation of an MR game (e.g., second MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the user 602's motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 638 can be used in conjunction with an MR device and/or an HIPD 642.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for case of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 6A-6C-2 provided above are intended to augment the description provided in reference to FIGS. 1-5. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

1. Smart glasses, comprising:
a lens frame;
a first nose pad coupled to the lens frame, wherein:
the first nose pad is rotatably coupled to the lens frame along a first axis; and
the first nose pad is configured to rotate between a first position and a second position, wherein the first position has a first angle along the first axis relative to a surface of the lens frame and the second position has a second angle along the first axis relative to the surface of the lens frame, wherein the first angle is different from the second angle.

2. The smart glasses of claim 1, further comprising:
a ratchet assembly comprising:
a first hinge coupled to the nose pad, wherein the first hinge and the first nose pad are rotatable relative to the lens frame;
a plunger in selective engagement with the first hinge, wherein the plunger resists rotation of the hinge; and
a spring biasing the plunger into engagement with the hinge.

3. The smart glasses of claim 2, wherein the plunger includes a plurality of teeth, wherein at least two teeth of the plurality of teeth are in engagement with the hinge in the first position.

4. The smart glasses of claim 2, wherein:
the plunger and the hinge are at least partially disengaged when the first nose pad is in a position other than the first position or the second position as the first nose pad rotates between the first position and the second position; and
the plunger and the hinge are engaged when the first nose pad is at the first position or the second position.

5. The smart glasses of claim 1, wherein:
the first nose pad is configured to rotate between the first position and the second position when a torque applied at a distal end of the first nose pad is greater than a threshold amount of torque, wherein the distal end of the first nose pad is a portion of the first nose pad that is farthest away from the surface of the lens frame; and
the first nose pad is configured to remain at a current position when the torque applied at the distal end of the first nose pad is less than the threshold amount of torque, wherein the current position is the first position or the second position.

6. The smart glasses of claim 1, wherein the smart glasses include an output device that is configured to present information indicating a current position of the first nose pad.

7. The smart glasses of claim 1, wherein the smart glasses include an output device that is configured to present a notification indicating that the first nose pad has rotated between the first position and the second position.

8. The smart glasses of claim 1, wherein the smart glasses include an actuator that controls movement of the first nose pad between the first position and the second position, wherein the actuator is electronically controlled by the smart glasses.

9. The smart glasses of claim 1, comprising:
a second nose pad coupled to the lens frame, wherein:
the second nose pad is rotatably coupled to the lens frame along a second axis that is different from the first axis; and
the second nose pad is configured to rotate between a third position and a fourth position, wherein the third position has a third angle along the second axis relative to the surface of the lens frame and the fourth position has a fourth angle along the second axis relative to the surface of the lens frame, wherein the third angle is different from the fourth angle.

10. The smart glasses of claim 9, wherein the third angle is the same as the first angle, and the fourth angle is the same as the second angle.

11. (canceled)

12. (canceled)

13. (canceled)

14. (canceled)

15. (canceled)

16. (canceled)

17. (canceled)

18. (canceled)

19. (canceled)

20. (canceled)
